(19) United States
(12) Patent Application Publication
(10) Pub. No.: US 2006/0129390 A1
(43) Pub. Date: Jun. 15, 2006

(54) Apparatus and method for remotely diagnosing laryngeal disorder/laryngeal state using speech codec

(76) Inventors: Hyun-Woo Kim, Seoul (KR); Do-Young Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/177,261

(22) Filed: Jul. 8, 2005

(30) Foreign Application Priority Data
Dec. 13, 2004 (KR) 10-2004-0105008

(51) Int. Cl. G10L 19/08

(52) U.S. Cl. 704/220

(57) ABSTRACT

Provided is an apparatus and method for remotely diagnosing laryngeal disorder/laryngeal state by using the speech codec. The apparatus provides a remote larynx diagnosing apparatus and method deciding laryngeal disorder/laryngeal state by using parameters, such as a Linear Prediction Coefficient (LPC) and a pitch, which are transmitted from a system using a speech codec. The apparatus includes a user information/speech codec information collecting block; a parameter extracting block for extracting the diagnosis parameter in bitstream transmitted from the network; a storing block for pre-storing a diagnosis parameter considering the type of the speech codec and a bit rate; a parameter comparing block for comparing the diagnosis parameter extracted from the parameter extracting block with the information of storing block; and a laryngeal disorder/laryngeal state determining block for diagnosing presence of laryngeal disorder/laryngeal state.

### FIELD OF THE INVENTION

The present invention relates to a remote service apparatus and method for remotely diagnosing laryngeal disorder/laryngeal state by using a speech codec; and, more particularly, to a remote larynx diagnosing apparatus and method for diagnosing laryngeal disorder/laryngeal state in a remote place through a communication system that uses a speech codec based on a linear prediction technology.

### DESCRIPTION OF RELATED ART

Generally, when speech data are transmitted based on a digital technology, a speech codec minimizing the quantity of information is used to save the bandwidth of a network. Most speech codecs are based on the linear prediction technology with the benefit of high compressibility.

Speech is generated as a person breathes out one's breath through a glottis and a vocal track. In other words, a noise-like air coming out from a lung has a cyclic form due to the vibration of a glottal cord and has resonance due to a vocal track. The speech codec based on the linear prediction technology can have a high compressibility by modeling the speech generating procedure. Herein, a source is modeled with a random excitation or a code excitation, and the vibration of vocal cords is modeled with a pitch filter. The resonance of the tube of the vocal cords is modeled with a linear prediction filter.

Thus, the speech codec based on the linear prediction technology has a Linear Prediction Coefficients (LPC) information, pitch information, and excitation information as parameters. That is, the speech codec quantizes three parameters expressing LPC (or LSP, ISP), pitch delay and gain, and excitation, and then compresses the quantized three parameters by changing them into bitstream. Representative speech codecs include “G.729A” and “G.723.1” used in an Internet Protocol (IP) network, and Enhanced Variable Rate Codec (EVRC), Qualcomm Code Excited Linear Prediction (QCELP), Adaptive Multi-Rate (AMR), and Selective Mode Vocoder (SMV) used in a wireless communication network.

Meanwhile, various technologies have been developed to diagnose laryngeal disorder by analyzing speech elements, or to decide the state of larynx. A recent research shows that a wave form of speech excitation reflects characteristics of an individual well and relates to a vocal quality and laryngeal disorder. Generally, acoustic features such as perturbation of excitation, noise, a spectrum feature, and cepstrum are used as a measure for diagnosing the laryngeal disorder. Also, a Linear Prediction Coefficient and a pitch are used directly, or after modified to diagnose the laryngeal disorder. At this time, the parameter used herein is similar to or the same as the parameter compressed with a speech codec.

On the other hand, there were attempts to diagnose the laryngeal disorder/laryngeal state through a network. One of the attempts is to extract a speech parameter after receiving user information and recording speech through a web, and to decide the presence of the laryngeal cancer, when a diagnosis on the presence of the laryngeal cancer is requested. However, the conventional diagnosis method has a problem that it requires a great deal of calculation because a parameter should be calculated directly from the recorded speech.

On the other hand, another conventional method is a technology to embed a speech analyzing chip in a terminal, and then access to a main server through a web board and receive detailed information about his/her speech analysis. The method causes a cost problem because a chip which is able to analyze body information and emotional state shown in speech should be embedded into a terminal additionally.

### SUMMARY OF THE INVENTION

It is, therefore, an object of the present invention to provide a remote larynx diagnosing apparatus for deciding laryngeal disorder/laryngeal state based on parameters, e.g. a Linear Prediction Coefficients (LPC) and a pitch, transmitted from a system using a speech codec, and a method thereof.

It is another object of the present invention to provide a remote larynx diagnosing apparatus for diagnosing laryngeal disorder/laryngeal state after receiving speech codec information through a communication system which uses the speech codec based on a linear prediction technology, and a method thereof.

In accordance with an aspect of the present invention, there is provided an apparatus for diagnosing laryngeal disorder/laryngeal state using a speech codec, which includes: a user information/speech codec information collecting block for collecting user information and a speech codec information which is used in an external device through an external network; a parameter extracting block for extracting a diagnosis parameter in bitstream transmitted from the network based on the speech codec information collected in the user information/speech codec information collecting block; a storing block for pre-storing a diagnosis parameter considering the type of the speech codec and a bit rate; a parameter comparing block for comparing the diagnosis parameter extracted from the parameter extracting block with the information of the storing block based on the speech codec information; and a laryngeal disorder/laryngeal state determining block for diagnosing presence of laryngeal disorder/laryngeal state based on the comparison result obtained in the parameter comparing block.

In accordance with another aspect of the present invention, there is provided a method for remotely diagnosing laryngeal disorder/laryngeal state, which includes the steps of: collecting user information and speech codec information which is used in an external device according to the setup of a call with an external user terminal; receiving data converted into bitstream in a speech codec of the user terminal by requesting speech data to the user terminal; acquiring a diagnosis parameter from the bitstream; comparing the acquired diagnosis parameter with information pre-established in a database considering a type of the speech codec and a bit rate; and determining presence of laryngeal disorder/laryngeal state by analyzing the comparison result based on a mean value and individual deviation to thereby produce a diagnosis result.

Thus, in order to solve the problem of much calculation amount in the conventional technology, the present invention diagnoses laryngeal disorder/laryngeal state remotely by receiving and using the speech codec information based on the conventional linear prediction technology through a network, which can remove the calculation procedure for parameters such as LPC and a pitch, or reduce the calculation amount remarkably. In addition, a limitation in space is decreased because the diagnosis can be made in all networks using the speech codec, and real-time diagnosing is possible due to the real-time operation of the speech codec.

Besides, to solve the cost problem of the conventional technology, the present invention uses parameters obtained by using a conventional speech codec. Thus, it can moderate a price because additional chip for analyzing speech is not needed. Also, it is easy to embody and provide the service because existing terminals and networks can be used.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a communication system to which the present invention is applied;

FIG. 2 is a block diagram illustrating a remote larynx diagnosing apparatus using a speech codec in accordance with an embodiment of the present invention; and

FIG. 3 is a flowchart describing a remote larynx diagnosing method using a speech codec in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter. In addition, if it is considered that detailed description on the prior art blur the point of the present invention, the detailed description will not be provided herein. The preferred embodiments of the present invention will be described in detail hereinafter with reference to the attached drawings.

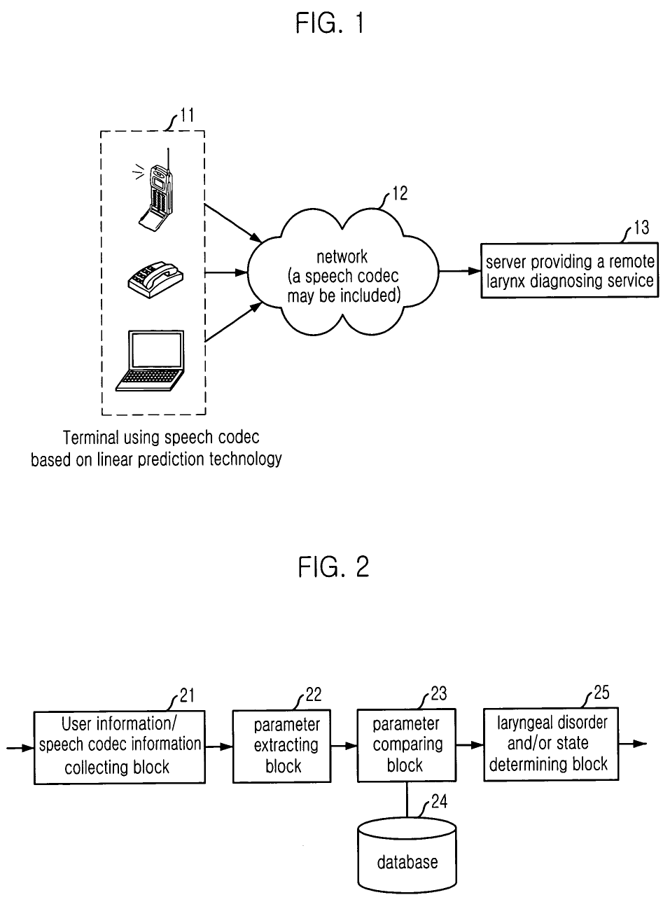

FIG. 1 is a block diagram showing a communication system to which the present invention is applied. It shows how to acquire information about laryngeal disorder/laryngeal state remotely in the entire communication system by using a speech codec based on a linear prediction technology.

First, referring to FIG. 2, the information acquisition procedure includes a process of converting the user speech into bitstream by using a speech codec based on a linear prediction technology, and transmitting the user speech with information about the speech codec to a server 13 which provides a remote larynx diagnosis service through a network 12 in a user terminal 11, and a process of extracting and modifying a parameter in the server 13 providing a remote laryngeal diagnosis service by processing LPC and a pitch directly/indirectly based on speech codec information, in which speech codec information of network can be included, in the bitstream transmitted through the network 12, comparing the extracted parameter with the information pre-stored in a database in consideration of speech codec information, and determining the presence of laryngeal disorder/laryngeal state.

These processes can be described more in detail as follows. For example, in case that a mobile communication terminal is used, the mobile communication terminal converts 21) parameters indicating LPC, pitch, and excitation into bitstream by using the speech codec such as Enhanced Variable Rate Codec (EVRC), Qualcomm Code Excited Linear Prediction (QCELP), after receiving speech, and then transmits the parameters.

On the other hand, in case that an Internet Protocol (IP) network is used, the IP network receives speech by using a Session Initiation Protocol (SIP) phone, a MEGACO phone, and a soft phone operated in a personal computer, converts parameters into bitstream by using a relevant speech codec such as “G.729A” and “G.723.1”, and then transmits the parameters.

The compressed information is transmitted to the server 13 providing the remote larynx diagnosing service through the network 12, i.e., a wireless network, IP network, and a telephone network to which users belong.

Then, the server 13 providing the remote larynx diagnosing service extracts and modifies parameters by processing LPC and a pitch directly/indirectly based on speech codec information which may include a speech codec information of the network in the bitstream transmitted through the network 12, compares the extracted parameters with information pre-stored in the database considering the type of the speech codec and a bit rate, and determines whether the laryngeal disorder exists, laryngeal state, and additional information such as whether additional examination is needed, and then transmits the diagnosis result to the user terminal 11 through the network 12.

FIG. 2 is a block diagram illustrating a remote larynx diagnosing apparatus using a speech codec in accordance with an embodiment of the present invention.

As shown in FIG. 2, the remote larynx diagnosing apparatus of the present invention using a speech codec includes a user information/speech codec information collecting block 21, a parameter extracting block 22, a database 24, a parameter comparing block 23 and a laryngeal disorder/laryngeal state determining block 25. The user information/speech codec information collecting block 21 collects user information and speech codec information which is used in a terminal and a network through an external network 12. The parameter extracting block 22 extracts diagnosis parameters such as LPC and the pitch in the bitstream transmitted from the network based on the speech codec information collected in the user information/speech codec information collecting block 21. The database 24 previously stores diagnosis parameters considering the type of a speech codec and a bit rate. The parameter comparing block 23 compares the diagnosis parameters extracted from the parameter extracting block 22 with the information of the database 24 based on the speech codec information. The laryngeal disorder/laryngeal state determining block 25 determines the presence of laryngeal disorder/laryngeal state based on the comparison result from the above parameter comparing block 23.

To describe the operation more in detail, when a call is set up between the user terminal 11 and the server 13 providing the remote larynx diagnosing service, the server finds out user information and speech codec information which is used in the terminal and the network. In other words, the server providing the remote larynx diagnosing service 13 gains the user information such as an identifier (ID), the age of a user, gender of the user, and a region and whether dialect is used through the user terminal 11, and finds out the speech codec information, such as the type of the speech codec, a bit rate, and whether a voice activity detector (VAD) and a Packet Loss Concealment (PLC) are used or not. In addition, the server 13 providing a remote larynx diagnosing service finds out whether transcoding has occurred in the network, and in case that the transcoding has occurred, the server 13 finds out whether the transcoding is of a tandem method or tandemless method.

Subsequently, the server 13 providing a remote larynx diagnosing service acquires a LPC, pitch delay and gain information based on the speech codec information in the bitstream transmitted through the network 12. The parameters can be used directly or used after modified and gaining other information. For example, variation of pitch can be gained. Furthermore, if more information is needed, other parameters can be extracted by using a decoder and synthesizing speech.

Subsequently, the server 13 providing a remote larynx diagnosing service performs a comparison process based on the database 24 which is pre-constructed in consideration of the type of the speech codec and the bit rate with respect to the extracted parameters. Herein, characteristics of each individual such as gender, age and region should be considered.

The diagnosis of the laryngeal disorder/laryngeal state is determined based on the comparison result obtained in the parameter comparing block 23.

To describe the process of determining the laryngeal disorder/laryngeal state more in detail with an example, it can be understood as a method of quantifying a comparison value of a database and parameters extracted by using an Itakura-Saito distortion measure. The method is widely used for speech analysis.

When it is assumed that x is an extracted parameter and y is a parameter of a specific laryngeal disorder with respect to a specific codec which is constructed in a database, a value obtained by comparing the two parameters d(x, y) is expressed as an equation.

$$d ( x , y ) = log \frac{{xR}_{x} {x}^{T}}{{yR}_{y} {y}^{T}} \qquad Eq . 1$$

where Rₓ and R_{y} are autocorrelation of x and y.

First, a comparison value d(x, y) is calculated, and then it is determined that there is laryngeal disorder, in case that the comparison value is larger than a pre-determined threshold. In case that the compared value is smaller than the threshold value, there is not laryngeal disorder. In the above example, the characteristics of each individual such as gender, age and region are not considered. This is an example determining the laryngeal state by after simple comparison.

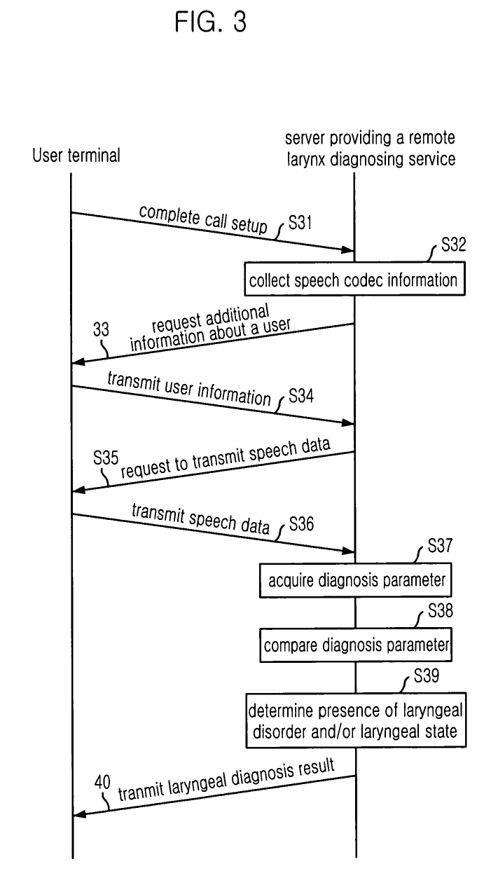

FIG. 3 is a flowchart describing a remote larynx diagnosing method using a speech codec in accordance with an embodiment of the present invention.

First, at step S31, a call is set up between a user terminal 11 and a server providing a remote larynx diagnosing service. After the call is set up, the server providing a remote larynx diagnosing service 13 collects speech codec information which is used in a terminal and the network.

Subsequently, at step S33, the server 13 providing the remote larynx diagnosing service requests the user terminal 11 to send additional user information. That is, the server 13 providing a remote larynx diagnosing service requests an ID for identifying a user, gender, age, job, region and whether a dialect is used or not, the present state of emotion, and whether to receive a detailed diagnosis result by E-mail or not. In some cases, the use of a high bit rate mode can be requested for the exact diagnosis when the user speech codec supports diverse bit rates. Also, the use of a wideband codec using 16 kHz sampling data can be requested for the exact diagnosis, in case that various user speech codecs are supported.

According to the above method, at step S34, the user terminal 11 outputs or displays the contents of the additionally required information, has the information be inputted or chosen, and then transmits the result of the user information into the server 13 providing a remote larynx diagnosing service.

At step S35, the server 13 providing a remote larynx diagnosing service receives the user information, validates the identifier, and requests the speech data to the user terminal 11. At this time, a specific pronunciation can be requested in order to extract more precise parameters.

At step S36, the user terminal 11 converts speech data inputted from a user into bitstream by using the speech codec based on the linear prediction technology and transmits the converted speech data to the server 13 providing a remote larynx diagnosing service. At this time, the relevant speech codec information can be transmitted together, which means that the process S32 can be performed in this process.

At step S37, the server 13 providing the remote larynx diagnosing service receives diagnosis parameters such as LPC and pitch information from the transmitted bitstream, and it can acquire more parameters by modifying the diagnosis parameter directly/indirectly. Also, the server 13 providing the remote larynx diagnosing service synthesizes speech by using a decoder for precise diagnosis of the laryngeal disorder/laryngeal state and then it can receive other parameters needed for the diagnosis.

Subsequently, at step S38, the server 13 providing a remote larynx diagnosing service compares the extracted diagnosis parameters with the information of the pre-established database 24 considering the type of the speech codec and the bit rate. Herein, characteristics of each individual such as gender, age and region should be considered.

At step S39, the presence of the laryngeal disorder/laryngeal state is determined by analyzing the comparison result based on the mean value and the individual deviation. Herein, the characteristics of the user and the speech codec information which are obtained in the above procedure are used.

At step S40, when the diagnosis result of laryngeal disorder/laryngeal state is transmitted, the additional information such as the difference with a past result and the date of a re-examination are also transmitted to the user terminal 11. A detailed diagnosis result can be transmitted through an E-mail or by a postal mail.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art, detailed description on it will not be provided herein.

The present invention described in the above receives speech codec information through the communication system, such as the terminal and the network, using speech codec based on the linear prediction technology, and then diagnoses the presence of laryngeal disorder/laryngeal state remotely.

That is, since the present invention receives speech codec information based on the linear prediction technology through a network and diagnoses laryngeal disorder/laryngeal state remotely, it can remove the mathematical procedure for obtaining the parameters such as LPC and a pitch, or reduce the calculation amount remarkably. In other words, since the invention uses the parameters of a conventional speech codec as the measuring means for laryngeal disorder/laryngeal sate diagnosis, it can reduce the amount of calculation for extracting the parameters needed to diagnose laryngeal disorder/laryngeal state from the speech considerably.

In addition, the limitation in time and space is decreased because it is possible to apply the present invention to all networks using the speech codec, and make a diagnosis in real-time due to the real-time operation of the speech codec.

Besides, the present invention does not require any additional chip for analyzing speech because it uses the previously received speech codec information, which moderates a price. In addition, it is easy to embody and provide the service because existing terminals and networks can be used.

The present application contains subject matter related to Korean patent application No. 2004-105008, filed with the Korean Patent Office on Dec. 13, 2004, the entire contents of which being incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for diagnosing laryngeal disorder/laryngeal state using a speech codec, comprising:
a user information/speech codec information collecting means for collecting user information and a speech codec information which is used in an external device through an external network;
a parameter extracting means for extracting a diagnosis parameter in bitstream transmitted from the network based on the speech codec information collected in the user information/speech codec information collecting means;
a storing means for pre-storing a diagnosis parameter considering the type of the speech codec and a bit rate;
a parameter comparing means for comparing the diagnosis parameter extracted from the parameter extracting means with the information of the storing means based on the speech codec information; and
a laryngeal disorder/laryngeal state determining means for diagnosing presence of laryngeal disorder/laryngeal state based on the comparison result obtained in the parameter comparing means.

2. The apparatus as recited in claim 1, wherein the parameter extracting means extracts the diagnosis parameter such as a Linear Prediction Coefficient (LPC) and pitch information from the bitstream converted by using the speech codec which is based on a linear prediction technology.

3. The apparatus as recited in claim 2, wherein the parameter extracting means extracts the diagnosis parameter such as a LPC, a pitch delay and gain information from the bitstream transmitted through the network based on the speech codec information, and modifies the extracted diagnosis parameter.

4. The apparatus as recited in claim 1, wherein the user information/speech codec information collecting means gains the user information such as an identifier (ID), age of a user, gender of a user, a region, and whether a dialect is used through a user terminal, and collects the speech codec information such as the type of the speech codec, a bit rate, and whether voice activity detection (VAD) and a Packet Loss Concealment (PLC) are used or not.

5. The apparatus as recited in claim 1, wherein the laryngeal disorder/laryngeal state determining means diagnoses the presence of the laryngeal disorder/laryngeal state by analyzing the comparison result of the parameter comparing means based on a mean value and an individual deviation.

6. A method for remotely diagnosing laryngeal disorder/laryngeal state, comprising the steps of:
a) collecting user information and speech codec information which is used in an external device according to the setup of a call with an external user terminal;
b) receiving data converted into bitstream in a speech codec of the user terminal by requesting speech data to the user terminal;
c) acquiring a diagnosis parameter from the bitstream;
d) comparing the acquired diagnosis parameter with information pre-established in a database considering a type of the speech codec and a bit rate; and
e) determining presence of a laryngeal disorder/laryngeal state by analyzing the comparison result based on a mean value and individual deviation to thereby produce a diagnosis result.

7. The method as recited in claim 6, further comprising a step of f) transmitting the diagnosis result to the user terminal.

8. The method as recited in claim 7, wherein, at the step f), additional information including difference between a present diagnosis result and a past diagnosis result and a re-examination data are transmitted to the user terminal together.

9. The method as recited in claim 6, wherein at the step c), the diagnosis parameter including an LPC and pitch information is extracted from the bitstream converted by using the speech codec based on the linear prediction technology.

10. The method as recited in claim 9, wherein at the step c), the diagnosis parameter including a LPC, a pitch delay and gain information is extracted from the bitstream transmitted through a network based on the speech codec information.
